(19) United States
(12) Patent Application Publication
(10) Pub. No.: US 2010/0143013 A1
(43) Pub. Date: Jun. 10, 2010

(54) IMAGE FORMING APPARATUS

(75) Inventor: Takahiro Azeta, Mishima-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/627,409

(22) Filed: Nov. 30, 2009

(30) Foreign Application Priority Data
Dec. 5, 2008 (JP) 2008-311368

(51) Int. Cl. G03G 15/00

(52) U.S. Cl. 399/381

(57) ABSTRACT

In an image forming apparatus, when a conveyance unit is attached to a main body hosing, a conveyance path for conveying the sheet again to the image forming unit is constituted by the conveyance unit and an upper surface of the housing.

### BACKGROUND OF THE INVENTION

1. Field of the Invention

The present invention relates to an image forming apparatus such as a copier and a printer, which has a function of forming an image on a recording material such as a sheet.

2. Description of the Related Art

Today, there is a widespread use of an image forming apparatus such as a printer and a copier, in which in order to perform automatic printing on the second side of a recording material, a two-sided conveyance path is unitized and mounted to the image forming apparatus which can perform only one-sided printing, whereby two-sided printing is realized.

The above image forming apparatus includes one which has a two-sided conveyance unit mounted in its main body to thereby have an automatic two-sided printing function (see, Japanese Patent Laid-Open Publication No. 2000-198564).

Further, there has been used an image forming apparatus which has a removable two-sided conveyance unit provided in the upper portion of the image forming apparatus which can perform only one-sided printing (for example, see Japanese Patent Laid-Open Publication No. 05(1993)-004417).

In the image forming apparatus described in Japanese Patent No. 3867663, in order to provide a reversing conveyance path for conveying a sheet vertically downward, a reversing conveyance unit is mounted to the main body of the image forming apparatus, and the remaining portion of a sheet guide constituting the reversing conveyance path is provided in the main body of the image forming apparatus.

In the constitution described in Japanese Patent Laid-Open Publication No. 2000-198564, in order to mount the two-sided conveyance unit in the image forming apparatus which can perform only one-sided printing, the image forming apparatus should have a space in which the two-sided conveyance unit can be mounted, and therefore, there is a problem of increasing the height of the image forming apparatus which can perform only one-sided printing.

Although the image forming apparatus described in Japanese Patent Laid-Open Publication No. 05 (1993)-004417 has the two-sided conveyance unit provided on its upper portion, a guide member for guiding the top and bottom of a recording material is provided in the two-sided conveyance unit, and therefore, there is a problem of increasing the height of the image forming apparatus which can perform two-sided printing. In the constitution described in Japanese Patent No. 3867663, the height direction of the image forming apparatus which can perform two-sided printing is not considered. Further features of the present invention will become apparent from the following description of exemplary embodiments with reference to the attached drawings.

### SUMMARY OF THE INVENTION

The present invention has been made in view of the above problems, and it is an object of the present invention to provide an image forming apparatus, which has a removable conveyance unit for forming an image on a second surface of a recording material formed with an image on its first surface and can realize a reduction in its height.

Another object of the present invention is to provide an image forming apparatus, which has an image forming unit forming an image on a sheet, a housing including therein the image forming unit, and a conveyance unit conveying the sheet with an image formed on a first surface by the image forming unit to the image forming unit again in order to form an image on a second surface of the sheet, and is attached to and removed from the upper portion of the housing. An image can be formed on one side of the sheet in such a state that the conveyance unit is not attached to the housing. Images can be formed on the both sides of the sheet in such a state that the conveyance unit is attached to the housing. When the conveyance unit is attached to the housing, a conveyance path for conveying the sheet again to the image forming unit is constituted by the conveyance unit and an upper surface of the housing.

A further object of the present invention is to provide an image forming apparatus, which has an image forming unit forming an image on a sheet, a housing including therein the image forming unit, and a conveyance unit conveying the sheet with an image formed on a first surface by the image forming unit to the image forming unit again in order to form an image on a second surface of the sheet, and is attached to and removed from the lower portion of the housing. An image can be formed on one side of the sheet in such a state that the conveyance unit is not attached to the housing. Images can be formed on the both sides of the sheet in such a state that the conveyance unit is attached to the housing. When the conveyance unit is attached to the housing, a conveyance path for conveying the sheet again to the image forming unit is constituted by the conveyance unit and a lower surface of the housing.

According to the present invention, the conveyance unit for forming an image on the second surface of the recording material formed with an image on its first surface is removably provided in the image forming apparatus, and the image forming apparatus can be reduced in size in the height direction.

### BRIEF DESCRIPTION OF THE DRAWINGS

FIG. 1 is a schematic cross-sectional view of an image forming apparatus according to a first embodiment of the present invention;

FIG. 2 is a schematic cross-sectional view of a main body of the image forming apparatus of the first embodiment of the present invention;

FIG. 3 is a schematic cross-sectional view of a two-sided unit of the first embodiment of the present invention;

FIG. 4 is a schematic cross-sectional view of an image forming apparatus according to a second embodiment of the present invention;

FIG. 5 is a schematic cross-sectional view of a main body of the image forming apparatus of the second embodiment of the present invention;

FIG. 6 is a schematic cross-sectional view of a two-sided unit of the second embodiment of the present invention;

FIG. 7A is a schematic cross-sectional view according to a modification of the second embodiment of the present invention;

FIG. 7B is a schematic cross-sectional view according to a modification of the second embodiment of the present invention;

FIG. 8 is a schematic cross-sectional view of an image forming apparatus of a reference embodiment 1;

FIG. 9 is a schematic cross-sectional view of a main body of the image forming apparatus of the reference embodiment 1;

FIG. 10 is a schematic view of a two-sided unit of the reference embodiment 1;

FIG. 11 is a schematic cross-sectional view of an image forming apparatus of a third embodiment;

FIG. 12 is a schematic cross-sectional view of a main body of the image forming apparatus of the third embodiment;

FIG. 13 is a schematic view of the main body of the image forming apparatus of the third embodiment as viewed from the bottom side thereof; and

FIG. 14 is a schematic cross-sectional view of a two-sided unit of the third embodiment.

### DESCRIPTION OF THE EMBODIMENTS

Hereinafter, the embodiments of the present invention will be exemplarily described in detail with reference to the drawings. However, the size, material, shape, and relative arrangement of components described in the embodiments should be appropriately modified depending on the configuration and various conditions of an apparatus to which the invention is applied, and it is not intended to limit the scope of the present invention only to the following embodiments.

### First Embodiment

A first embodiment of an image forming apparatus according to the present invention, which has a two-sided conveyance path (a recording material conveyance path), will be described with the drawings.

### (Entire Constitution of Image Forming Apparatus)

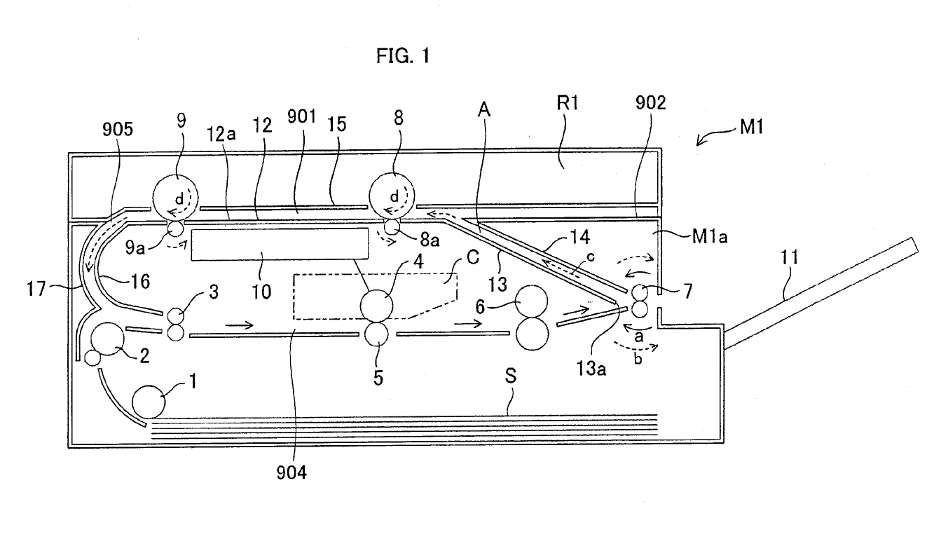

First, the entire constitution of the image forming apparatus is described with reference to FIG. 1. FIG. 1 is a cross-sectional view illustrating a schematic constitution of the image forming apparatus according to the present embodiment.

In FIG. 1, an image forming apparatus M1 using an electrophotographic system has a feed roller 1, a conveyance roller pair 2, a registration roller pair 3, a photosensitive drum (an electrophotographic photosensitive member) 4 as an image bearing member, a transfer roller 5, a fixing roller pair 6, a normally and reversely rotatable discharging roller 7 (pair of rollers), conveyance rollers 8 and 9, rollers 8a and 9a respectively in press-contact with the conveyance rollers 8 and 9, a laser scanner 10, and a discharge and stack tray 11. The image forming apparatus M1 further has a horizontal main conveyance path 904 provided between the registration roller pair 3 and the fixing roller pair 6.

Furthermore, the image forming apparatus M1 has a reversing path A which guides a recording material, conveyed by the discharging roller 7, into a two-sided conveyance path 901. The two-sided conveyance path 901 is for use in guiding a recording material S to be conveyed again to an image forming unit so that an image is formed on the second surface of the recording material S with an image formed on the first surface by the image forming unit. The image forming apparatus M1 has an introduction path 905 constituted of guides 16 and 17. The introduction path 905 guides the sheet conveyed in the two-sided conveyance path 901 to the main conveyance path 904.

In FIG. 1, the image forming apparatus M1 has a main body housing 902 of an image forming apparatus body (hereinafter, referred to as an “apparatus body”) M1a and a two-sided unit R1 as a conveyance unit. The two-sided unit R1 is removably attached to the upper portion of the main body housing 902.

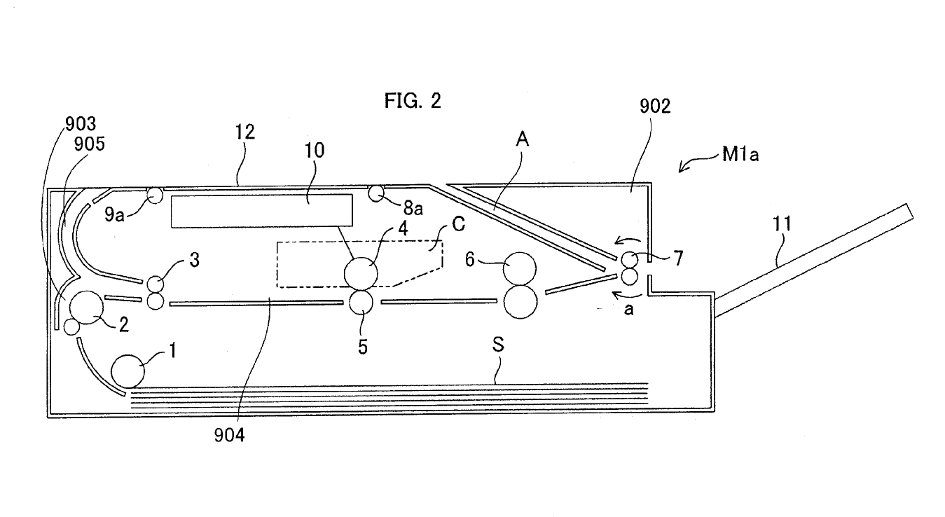

FIG. 2 is a schematic cross-sectional view illustrating the image forming apparatus in such a state that the two-sided unit R1 is removed from the apparatus body M1a.

In FIG. 2, an exterior portion 12 of the main body housing 902 of the apparatus body M1a has an embossing on the surface, whereby a welding line and a sink mark in the molding are rendered unnoticeable.

The main body housing 902 has the rollers 8a and 9a on the upper portion.

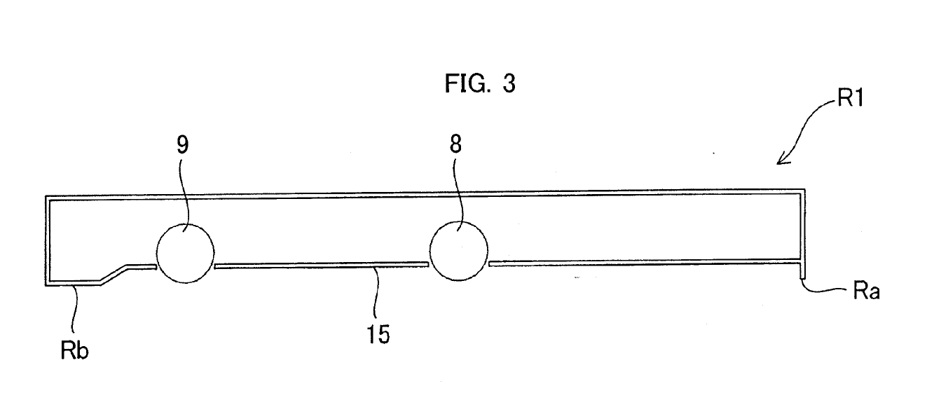

FIG. 3 is a schematic cross-sectional view illustrating the two-sided unit R1 which is a conveyance unit removably provided on the apparatus body M1a illustrated in FIG. 1, and the two-sided unit R1 is removed from the apparatus body M1a.

As illustrated in FIG. 3, the two-sided unit R1 is provided with a guide 15 as a guide part constituting the two-sided conveyance path 901 and the conveyance rollers 8 and 9.

Returning to FIG. 1, the two-sided unit R1 illustrated in FIG. 3 is mounted (attached) to the main body housing 902 illustrated in FIG. 2, whereby the two-sided unit R1 is in electrically and mechanically contact with the main body housing 902, and the conveyance rollers 8 and 9 are in a drivable state.

Then, the conveyance roller 8 and the roller 8a are in a press-contact state, and the conveyance roller 9 and the roller 9a are in a press-contact state, whereby the recording material S can be conveyed in the two-sided conveyance path 901.

Next, returning to FIG. 2, there is described the operation of the apparatus body M1a in such a state that the two-sided unit R1 is not mounted thereto.

In FIG. 2, the recording material S contained in a feeding part is separated and fed one by one by the feed roller 1 to pass through the conveyance roller 2, and, thus, to be conveyed to the registration roller pair 3. Namely, the recording material S is conveyed in a curved path 903 by the feed roller 1 and the conveyance roller 2.

The registration roller pair 3 corrects the skew of the recording material S and restarts the feeding of the recording material S at a predetermined timing.

In a process cartridge C, after the photosensitive drum 4 as an image bearing member is uniformly charged by charging unit (not illustrated), a latent image is formed thereon by a laser beam from a laser scanner unit 10 as exposure unit. Then, toner is adhered to the latent image by development unit (not illustrated), whereby a toner image is formed on the photosensitive drum 4. The toner image formed on the photosensitive drum 4 is transferred onto the recording material S by the transfer roller 5 as transfer unit. The photosensitive drum 4, the charging unit, the laser scanner unit 10, the development unit, and the transfer roller 5 constitute an image forming unit. The toner image is transferred onto the recording material S by the transfer roller 5 while the recording material S is conveyed in a main conveyance path 904.

The recording material S transferred with the toner image is conveyed to the fixing roller pair 6, serving as fixing unit, by a conveying force of the photosensitive drum 4 and the transfer roller 5. Then, heat and pressure are applied to the recording material S, transferred with the toner image, by the fixing roller pair 6, and consequently, the toner image is fixed to the recording material S.

The recording material S fixed with the toner image is discharged on the tray 11 by the discharging roller 7 rotating in the direction of the solid arrow a.

According to the above constitution, the one-sided printing can be performed by the apparatus body M1a.

Next, returning to FIG. 1 again, there is described the operation of the image forming apparatus M1 in such a state that the two-sided unit R1 is mounted thereto.

As described above, when automatic two-sided printing is performed, the two-sided unit R1 is mounted to the upper portion of the apparatus body M1a. Protrusions Ra and Rb of the two-sided unit R1 are in contact with the exterior portion 12, whereby the position of the two-sided unit R1 with respect to the main body housing 902 of the apparatus body M1a is determined.

As in the one-sided printing, the recording material S contained in the feeding part is separated and fed one by one by the feed roller 1 to pass through the conveyance roller pair 2, and, thus, to be conveyed to the registration roller pair 3. The registration roller pair 3 corrects the skew of the recording material S and restarts the feeding of the recording material S at a predetermined timing.

After the photosensitive drum 4 provided in the process cartridge C is uniformly charged by the charging unit, a latent image is formed thereon by the laser beam from the laser scanner unit 10. Then, toner is adhered to the latent image by the development unit, whereby a toner image is formed on the photosensitive drum 4. The toner image formed on the photosensitive drum 4 is transferred onto the recording material S by the transfer roller 5.

The recording material S transferred with the toner image is conveyed to the fixing roller pair 6 by the conveying force of the photosensitive drum 4 and the transfer roller 5. Then, heat and pressure are applied to the recording material S, transferred with the toner image, by the fixing roller pair 6, and consequently, the toner image is fixed to the recording material S.

The recording material S fixed with the toner image is led to the discharging roller 7 rotating in the direction of the solid arrow a.

When printing on the second surface of the recording material S is performed, detection unit (not illustrated) detects that the rear end of the recording material S has passed a recording material guide end 13a, whereby the discharging roller 7 rotates in the direction of the dashed arrow b to make the recording material S switchback.

The switchbacked recording material S is conveyed in the direction of the dashed arrow c in a reversing path A constituted of the guides (conveyance guides) 13 and 14. The sheet having passed through the reversing path A is conveyed in the two-sided conveyance path 901.

Further, the recording material S is led by the guide 15 of the two-sided unit R1 and the exterior portion 12, which is the upper surface of the main body housing 902 of the apparatus body M1a. The recording material S is then conveyed to the conveyance roller pair 8 and 8a by the guide 15 of the two-sided unit R1 and the exterior portion 12, which is the upper surface of the main body housing 902 of the apparatus body M1a. The two-sided conveyance path 901 is constituted of the guide 15 of the two-sided unit R1 and an opposing portion (facing portion) 12a of the exterior portion 12, which is the upper surface of the main body housing 902 and opposing the guide 15.

In the present embodiment, since the two-sided conveyance path 901 is constituted of the exterior portion 12 with the embossing, it is possible to further reduce the area of the recording material S in contact with the exterior portion 12 operated as a guide, whereby the occurrence of electrostatic adsorption can be suppressed.

The opposing portion 12a of the exterior portion 12 may have ribs formed along the conveying direction.

When the recording material S is conveyed immediately before the conveyance roller pair 8 and 8a (near the upstream side in the direction of conveying the recording material S), the recording material S is detected by detection unit (not illustrated), whereby the conveyance roller pair 8 and 8a and the conveyance roller pair 9 and 9a are rotated in the direction of the dashed arrow d.

The recording material S conveyed by the conveyance roller pair 8 and 8a and the conveyance roller pair 9 and 9a is conveyed in the two-sided conveyance path 901 while led by the exterior portion 12 and the guide 15 and introduced into the introduction path 905 constituted of guides 16 and 17. The recording material S is conveyed again to the registration roller pair 3 through the introduction path 905.

The registration roller pair 3 corrects the skew of the recording material S and restarts the feeding of the recording material S at a predetermined timing.

The toner image for the second surface of the recording material S formed as well as the case of the first surface is transferred onto the recording material S by the transfer roller 5 as the transfer unit.

The recording material S with the toner image transferred on the second surface is conveyed to the fixing roller pair 6 by the conveying force of the photosensitive drum 4 and the transfer roller 5. Thereafter, heat and pressure are applied to the recording material S, transferred with the toner image, by the fixing roller pair 6, and consequently, the toner image is fixed onto the second surface of the recording material S.

As in the one-sided printing, the recording material S with the toner image fixed onto the second surface is discharged on the tray 11 by the discharging roller 7 rotating in the direction of the solid arrow a.

According to the above constitution, the two-sided printing can be performed.

The above constitution can provide the following effects.

Namely, the exterior portion 12 of the apparatus body M1a is used as the two-sided conveyance path 901, and consequently the height of the image forming apparatus M1 mounted with the two-sided unit R1 can be further reduced, whereby the image forming apparatus M1 can be reduced in size.

Further, since the two-sided unit R1 may have only the one-side guide 15 as the guide of the recording material, the two-sided unit R1 can be reduced in size, whereby cost reduction can be realized.

Since the two-sided conveyance path 901 is constituted of the exterior portion 12 with the embossing, it is possible to further reduce the area of the recording material S in contact with the exterior portion 12 operated as a guide, whereby the occurrence of electrostatic adsorption can be suppressed. Thus, the two-sided conveyance path which can realize more stable conveyance of the recording material can be obtained.

Since the main conveyance path 904 and the two-sided conveyance path 901 are horizontally provided, the height of the apparatus can be reduced.

### Second Embodiment

Next, the second embodiment of the image forming apparatus according to the present invention, which has the two-sided conveyance path (the recording material conveyance path), is described with the drawings.

### (Entire Constitution of Image Forming Apparatus)

The second embodiment is different from the first embodiment in the constitutions of the conveyance roller pair 8 and 8a and the conveyance roller pair 9 and 9a. In the second embodiment, components similar to those in the first embodiment are represented by the same numbers, and thus description thereof will not be repeated.

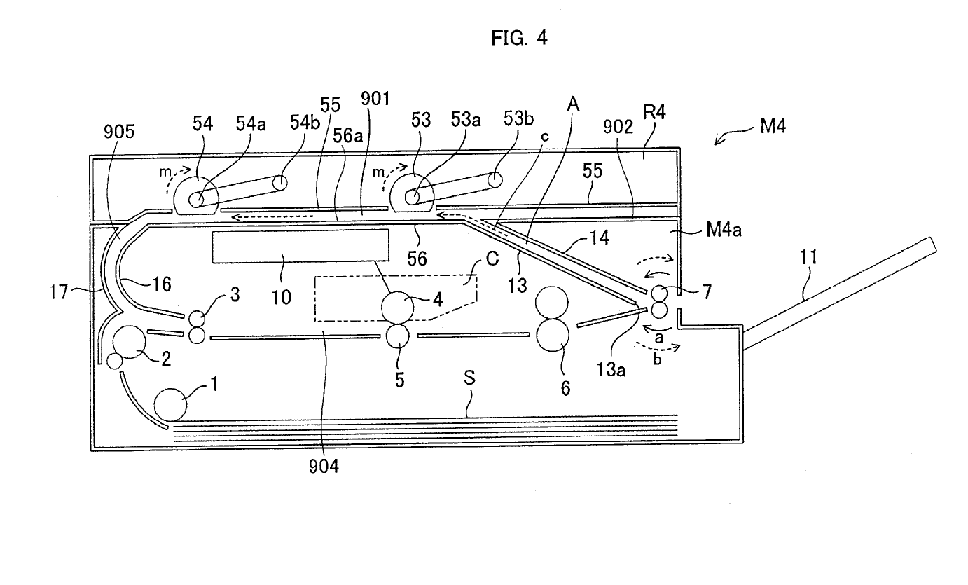

First, the entire constitution of the image forming apparatus is described with reference to FIG. 4. FIG. 4 is a cross-sectional view illustrating a schematic constitution of the image forming apparatus according to the present embodiment.

In FIG. 4, an image forming apparatus M4 using the electrophotographic system has D-shaped conveying rollers 53 and 54 (hereinafter, referred to as D-shaped rollers).

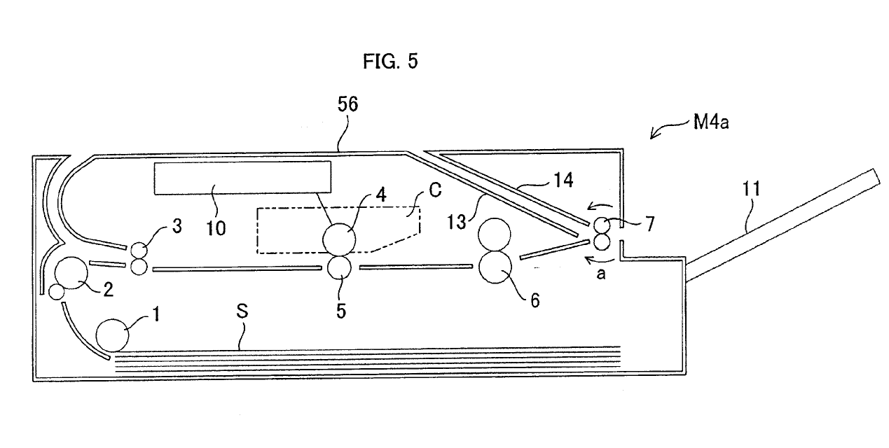

FIG. 5 is a schematic cross-sectional view illustrating an image forming apparatus body (hereinafter, referred to as an apparatus body) M4a of the image forming apparatus M4 illustrated in FIG. 4, which can perform only one-sided printing. The apparatus body M4a has a main body housing 902.

In FIG. 5, an exterior portion 56 of the apparatus body M4a is the upper surface of the main body housing 902. The exterior portion 56 has an embossing on the surface, whereby a welding line and a sink mark in the molding are rendered unnoticeable.

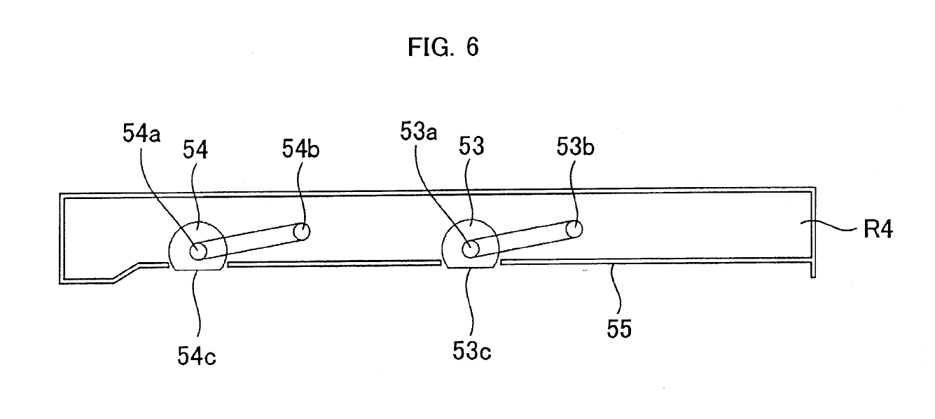

FIG. 6 is a schematic cross-sectional view illustrating a two-sided unit R4 as a conveyance unit removably provided in the upper portion of the image forming apparatus M4 illustrated in FIG. 4, and the two-sided unit R4 is removed from the image forming apparatus M4.

As illustrated in FIG. 6, the two-sided unit R4 includes a guide 55 as a guide part constituting a two-sided conveyance path 901 and the D-shaped rollers 53 and 54.

Returning to FIG. 4, the two-sided unit R4 illustrated in FIG. 6 is mounted to the upper portion of the apparatus body M4a illustrated in FIG. 5, whereby the two-sided unit R4 is in electrically and mechanically contact with the apparatus body M4a, and the D-shaped rollers 53 and 54 are in a drivable state.

In the apparatus body M4a, a recording material S is discharged on the tray 11 through the image forming process similar to that of the first embodiment.

According to the above constitution, the one-sided printing can be performed by the apparatus body M4a.

Next, returning to FIG. 4 again, the operation of the image forming apparatus M4 mounted with the two-sided unit R4 is described.

As in the first embodiment, when the automatic two-sided printing is performed, the two-sided unit R4 is mounted to the upper portion of the apparatus body M4a.

As in the one-sided printing, the recording material S contained in a feeding part is subjected to the transfer and fixing operation to be led by a discharging roller 7 rotating in the direction of the solid arrow a.

When printing on the second surface of the recording material S is performed, detection unit (not illustrated) detects that the rear end of the recording material S has passed a recording material guide end 13a, whereby the discharging roller 7 rotates in the direction of the dashed arrow b to make the recording material S switchback.

The switchbacked recording material S is conveyed in the direction of the dashed arrow c in a reversing path A by guides 13 and 14. The recording material S is guided into the two-sided conveyance path 901 through the reversing path A.

Further, the recording material S is conveyed to the D-shaped roller 53 through the two-sided conveyance path 901 while being led by a guide 55 of the two-sided unit R4 and the exterior portion 56 of the apparatus body M4a. The two-sided conveyance path 901 is constituted of the guide 55 and an opposing portion 56a, which is a portion of the exterior portion 56 and opposing the guide 55.

In the present embodiment, since the exterior portion 56 with the embossing is the two-sided conveyance path, it is possible to further reduce the area of the recording material S in contact with the exterior portion 56 operated as a guide, whereby the occurrence of electrostatic adsorption can be suppressed.

In the two-sided unit R4, the D-shaped rollers 53 and 54 are normally held so that D-cut portions 53c and 54c are directed downward (in the vertical direction in such a state that the two-sided unit R4 is mounted to the apparatus body M4a).

The D-shaped roller 53 can be swung around a fulcrum 53b, and drive is transmitted from the fulcrum 53a to the D-shaped roller 53, whereby the D-shaped roller 53 is rotated.

The D-shaped roller 54 can be swung around a fulcrum 54b, and drive is transmitted from the fulcrum 54a to the D-shaped roller 54, whereby the D-shaped roller 54 is rotated.

When detection unit (not illustrated) detects that the recording material S is led under the D-shaped roller 53, the D-shaped roller 53 is rotated in the dashed line direction.

According to the above constitution, the recording material S is press-fitted between the D-shaped roller 53 and the exterior portion 56 and consequently conveyed in a two-sided conveyance path 901. Namely, the recording material S is conveyed while held between the D-shaped roller 53 and the opposing portion 56a.

The D-shaped roller 53 rotates until the recording material S reaches under the D-shaped roller 54 and thereafter stops so that the D-cut portion 53c is directed downward.

The recording material S led under the D-shaped roller 54 rotates in the direction of the dashed arrow m as with the D-shaped roller 53.

According to the above constitution, the recording material S is conveyed in the two-sided conveyance path 901 to reach a registration roller pair 3. Namely, the recording material S is conveyed while held between the D-shaped roller 54 and the opposing portion 56a, and the D-shaped roller 54 conveys the recording material S to the registration roller pair 3 while allowing the recording material S to pass through an introduction path 905.

After the skew of the recording material S is corrected by the registration roller pair 3, the registration roller pair 3 rotates at a predetermined timing, whereby the recording material S is conveyed to a photosensitive drum 4. After the registration roller pair 3 starts to rotate, the D-shaped roller 54 stops so that the D-cut portion 54c is directed downward.

The toner image for the second surface of the recording material S formed in the same manner as for the first surface is transferred onto the recording material S by a transfer roller 5.

The recording material S with the toner image transferred on the second surface is conveyed to a fixing roller pair 6 by the conveying force of the photosensitive drum 4 and the transfer roller 5. Then, heat and pressure are applied to the recording material S with the toner image transferred onto the second surface by the fixing roller pair 6, and consequently, the toner image is fixed onto the second surface of the recording material S.

As in the one-sided printing, the recording material S with the toner image fixed onto the second surface is discharged on the tray 11 by the discharging roller 7 rotating in the direction of the solid arrow a.

According to the above constitution, the two-sided printing can be performed.

In the present embodiment, by virtue of the use of the D-shaped rollers, the rollers 8a and 9a of the first embodiment can be eliminated.

According to the above constitution, the following effects can be obtained.

Namely, the exterior portion 56 of the image forming apparatus body M4a is used as the two-sided conveyance path, whereby the height of the image forming apparatus M4 mounted with the two-sided unit can be further reduced, and thus the image forming apparatus M4 can be reduced in size.

Further, the two-sided unit R4 may have only the one-side guide 55 as the guide for the recording material, and therefore, the two-sided unit R4 can be reduced in size, whereby cost reduction can be realized.

Furthermore, since the exterior portion 56 with the embossing is used as the two-sided conveyance path, it is possible to further reduce the area of the recording material S in contact with the exterior portion 56 operated as a guide, whereby the occurrence of electrostatic adsorption can be suppressed. Thus, the two-sided conveyance path which can realize more stable conveyance of the recording material can be obtained.

Furthermore, by virtue of the use of the D-shaped rollers 53 and 54 (since the conveyance unit is constituted of the D-shaped rollers 53 and 54 and the exterior portion 56), the rollers are not required to be provided, and therefore, the constitution of the apparatus body M4a can be simplified, whereby cost reduction can be realized.

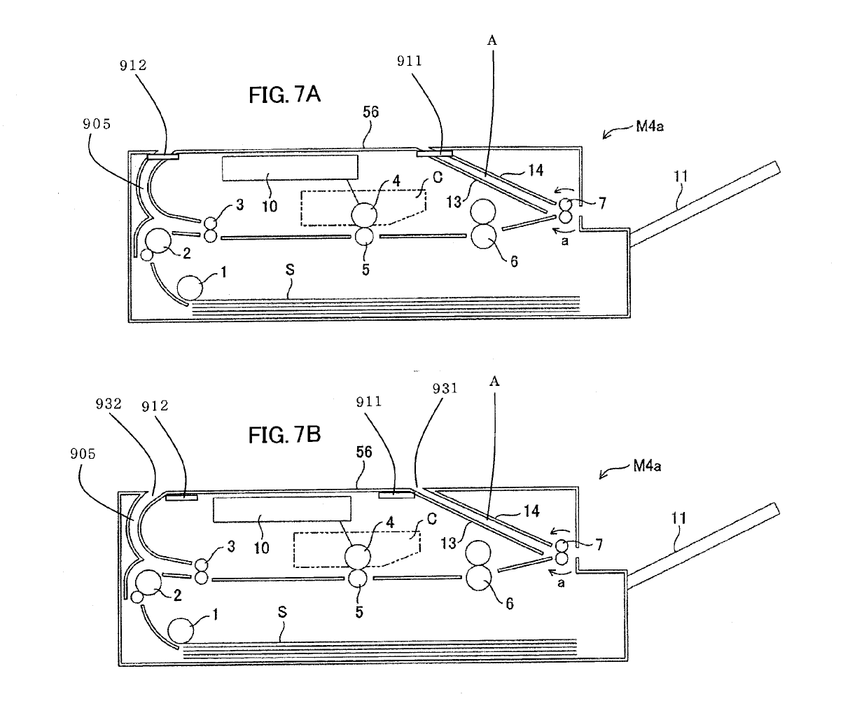

In the above embodiments, the exterior portion which is the upper surface of the main body housing 902 has openings corresponding to the exit of the reversing path A and the entrance of the introduction path 905. The main body housing 902 may have shutters for closing the openings. FIGS. 7A and 7B are cross-sectional views of the apparatus body in the modification using the shutters.

In FIG. 7, the main body housing 902 has on its upper surface a first opening 931 as the exit of the reversing path A and a second opening 932 as the entrance of the introduction path 905. The main body housing 902 further has a movable first shutter 911 which can close the first opening 931 and a movable second shutter 912 which can close the second opening 932.

In FIG. 7A, the first shutter 911 is positioned at a closing position closing the first opening 931, and the second shutter 912 is positioned at a closing position closing the second opening 932. In FIG. 7B, the first shutter 911 is positioned at an opening position opening the first opening 931, and the second shutter 912 is positioned at an opening posit ion opening the second opening 932.

The two-sided unit is attached to the upper portion of the main body housing 902 as in the above embodiments in such a state that the first shutter 911 and the second shutter 912 are positioned as illustrated in FIG. 7B.

When the apparatus body M4a is used without mounting the two-sided unit, the first shutter 911 and the second shutter 912 are positioned at the closing position as illustrated in FIG. 7A. Since the introduction path 905 and the reversing path A are closed by the first shutter 911 and the second shutter 912, the ingress of dust is prevented. The first shutter 911 and the second shutter 912 are positioned continuous with the exterior portion, and therefore, when the two-sided unit is not mounted, the exterior of the apparatus body M4a is neat, and thus the appearance is improved.

In the modification, although the first and second shutters slide and move, they may be swingably attached to the main body housing 902. The two-sided unit is mounted so that each shutter is abutted against a portion of the two-sided unit, whereby the shutter may be moved from the closing position to the position opening the opening in conjunction with the mounting operation of the two-sided unit. The first and second shutters may be removably provided in the main body housing in order to close the first and second openings.

### Reference Embodiment 1

Next, a reference embodiment 1 of the image forming apparatus having the two-sided conveyance path (the recording material conveyance path) is described with the drawings.

### (Entire Constitution of Image Forming Apparatus)

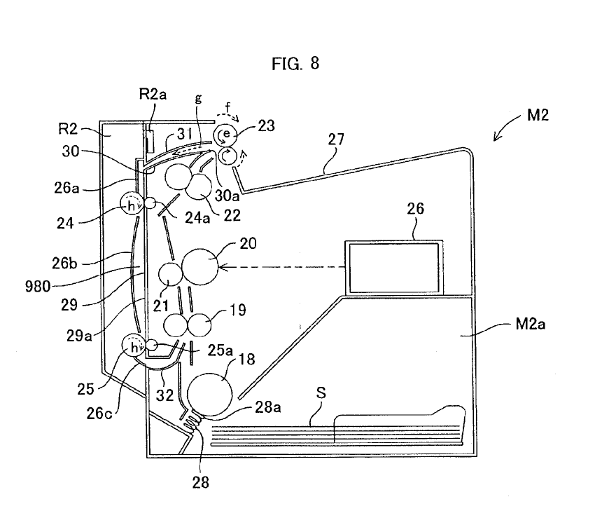

First, the entire constitution of the image forming apparatus is described with reference to FIG. 8. FIG. 8 is a cross-sectional view illustrating a schematic constitution of the image forming apparatus according to this embodiment.

In FIG. 8, an image forming apparatus M2 using an electrophotographic system has a feed roller 18, a conveyance roller pair 19, a photosensitive drum (an electrophotographic photosensitive member) 20 as an image bearing member, a transfer roller 21, a fixing roller pair 22, a normally and reversely rotatable discharging roller 23, conveyance rollers 24 and 25, rollers 24a and 25a respectively in press-contact with the conveyance rollers 24 and 25, a laser scanner 26, and a discharge and stack tray 27, and a spring 28 which brings a separation pad 28a in press-contact with the feed roller 18. The image forming apparatus M2 further has a recording material conveyance path 980 is for use in conveying the recording material S again to image forming unit so that an image is formed on the second surface of the recording material S with an image formed on the first surface by the image forming unit.

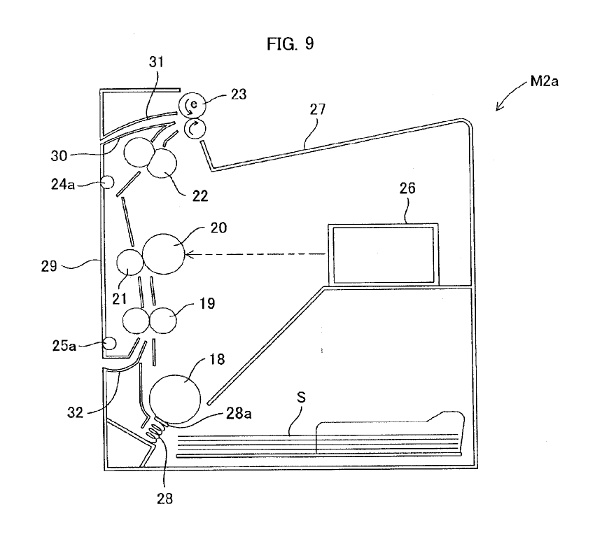

FIG. 9 is a schematic cross-sectional view illustrating an image forming apparatus body (hereinafter, referred to as an apparatus body) M2a of the image forming apparatus M2 illustrated in FIG. 8, which can perform only one-sided printing.

In FIG. 9, the apparatus body M2a has an exterior portion 29.

Further, the exterior portion 29 has the rollers 24a and 25a.

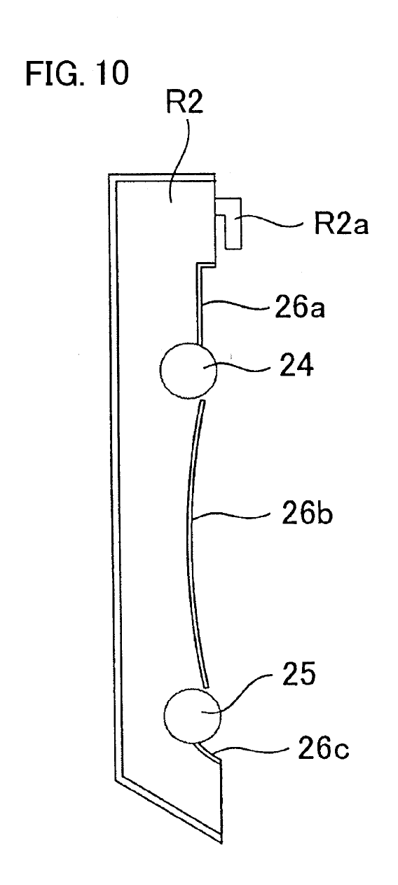

FIG. 10 is a schematic cross-sectional view illustrating a two-sided unit R2 as a conveyance unit removably provided on the side surface (the side portion) of the image forming apparatus M2 illustrated in FIG. 8 and the two-sided unit R2 is removed from the image forming apparatus M2. The two-sided unit R2 is mounted to the apparatus body M2a so as to be adjacent to the apparatus body M2a in the horizontal direction, whereby the image forming apparatus M2 is constituted.

As illustrated in FIG. 10, the two-sided unit R2 has guides 26a, 26b, and 26c as guide parts constituting the recording material conveyance path 980 and the conveyance rollers 24 and 25.

Returning to FIG. 8, the two-sided unit R2 illustrated in FIG. 10 is mounted to the side surface (the left side in FIGS. 8 and 9) of the apparatus body M2a illustrated in FIG. 9, whereby the two-sided unit R2 is in electrically and mechanically contact with the apparatus body M2a, and the conveyance rollers 24 and 25 are in a drivable state.

Then, the conveyance roller 24 and the roller 24a are in a press-contact state, and the conveyance roller 25 and the roller 25a are in a press-contact state, whereby the recording material S can be conveyed.

Next, returning to FIG. 9, the operation of the apparatus body M2a is described.

In FIG. 9, the recording material S contained in the feeding part is separated and fed one by one by the feed roller 18 to pass through the conveyance roller 19, and, thus, to be conveyed to the photosensitive drum 20.

In a process cartridge (not illustrated), after the photosensitive drum 20 is uniformly charged by charging unit (not illustrated), a latent image is formed thereon by the laser beam from a laser scanner unit 26 as exposure unit. Then, toner is adhered to the latent image by development unit (not illustrated), whereby a toner image is formed on the photosensitive drum 20. The toner image formed on the photosensitive drum 20 is transferred onto the recording material S by the transfer roller 21 as transfer unit. The image bearing member (corresponding to the photosensitive drum 20), the charging unit, the exposure unit (corresponding to the laser scanner unit 26), the development unit, and the transfer unit (corresponding to the transfer roller 21) constitute image forming unit.

The recording material S transferred with the toner image is conveyed to the fixing roller pair 22, serving as fixing unit, by the conveying force of the photosensitive drum 20 and the transfer roller 21. Then, heat and pressure are applied to the recording material S, transferred with the toner image, by the fixing roller pair 22, and consequently, the toner image is fixed to the recording material S.

The recording material S fixed with the toner image is discharged on the tray 27 by the discharging roller 23 rotating in the direction of the solid arrow e.

According to the above constitution, the one-sided printing can be performed by the apparatus body M2a.

Next, returning to FIG. 8 again, the operation of the image forming apparatus M2 mounted with the two-sided unit R2 is described.

As described above, when the automatic two-sided printing is performed, the two-sided unit R2 is mounted to the side of the apparatus body M2a. A protrusion R2a of the two-sided unit R2 is caught by the apparatus body M2a, whereby the two-sided unit R2 is positioned with respect to the apparatus body M2a.

As in the one-sided printing, the recording material S contained in the feeding part is separated and fed one by one by the feed roller 18 to pass through the conveyance roller 19, and, thus, to be conveyed to a nip portion between the photosensitive drum 20 and the transfer roller 21.

After the photosensitive drum 20 provided in the process cartridge is uniformly charged by the charging unit, a latent image is formed thereon by the laser beam from the laser scanner unit 26 as exposure unit. Then, toner is adhered to the latent image by the development unit, whereby a toner image is formed on the photosensitive drum 20. The toner image formed on the photosensitive drum 20 is transferred onto the recording material S by the transfer roller 21 as transfer unit.

The recording material S transferred with the toner image is conveyed to the fixing roller pair 22, serving as fixing unit, by the conveying force of the photosensitive drum 20 and the transfer roller 21. Then, heat and pressure are applied to the recording material S, transferred with the toner image, by the fixing roller pair 22, and consequently, the toner image is fixed to the recording material S.

The recording material S fixed with the toner image is led by the discharging roller 23 rotating in the direction of the solid arrow e.

When printing on the second surface of the recording material S is performed, detection unit (not illustrated) detects that the rear end of the recording material S has passed a recording material guide end 30a, whereby the discharging roller 23 rotates in the direction of the dashed arrow f to make the recording material S switchback.

The switchbacked recording material S is conveyed in the direction of the dashed arrow g in the recording material conveyance path 980 while guided by guides 30 and 31.

Further, the recording material S is conveyed to the conveyance roller pair 24 and 24a in the recording material conveyance path 980 while led by the guide 26a of the two-sided unit R2 and the exterior portion 29 of the apparatus body M2a. The recording material conveyance path 980 is constituted of the guides 26a, 26b, and 26c and an opposing portion 29a, which is a portion of the exterior portion 29 and opposing the guides 26a, 26b, and 26c.

When the recording material S is conveyed immediately before the conveyance roller pair 24 and 24a (near the upstream side in the direction of conveying the recording material S), the recording material S is detected by detection unit (not illustrated), whereby the conveyance roller pair 24 and 24a and the conveyance roller pair 25 and 25a are rotated in the direction of the dashed arrow h.

While the recording material S is led by the exterior portion 29 of the apparatus body M2a and the guides 26a, 26b, and 26c, the recording material S is conveyed in the recording material conveyance path 980 by the conveyance roller pair 24 and 24a and the conveyance roller pair 25 and 25a to be led to the guide 32. The recording material S is conveyed again to the conveyance roller pair 19.

As in the first surface, the recording material S with the toner image transferred on the second surface is conveyed to the fixing roller pair 22 by the conveying force of the photosensitive drum 20 and the transfer roller 21. Thereafter, heat and pressure are applied to the recording material S by the fixing roller pair 22, and consequently, the toner image is fixed onto the second surface of the recording material S.

As in the one-sided printing, the recording material S with the toner image fixed onto the second surface is discharged on the tray 27 by the discharging roller 23 rotating in the direction of the solid arrow e.

According to the above constitution, the two-sided printing can be performed.

The above constitution can provide the following effects.

Namely, in the image forming apparatus M2 constituted by mounting the two-sided unit R2 to the side portion, the exterior portion 29 of the side surface of the apparatus body M2a is used as the recording material conveyance path, and consequently, the increase of size in the width direction can be prevented, whereby the compact configuration can be realized.

Since the two-sided unit R2 may have only the one-side guides 26a, 26b, and 26c as the guides of the recording material, cost reduction can be realized, and, at the same time, the thickness of the two-sided unit R2 can be reduced, leading to the size reduction.

Since the exterior portion 29 with the embossing is used as the recording material conveyance path, it is possible to further reduce the area of the recording material S in contact with the exterior portion 29 operated as a guide, whereby the occurrence of electrostatic adsorption can be suppressed. Thus, the recording material conveyance path which can realize more stable conveyance of the recording material can be obtained.

### Third Embodiment

Next, a third embodiment of the image forming apparatus having the two-sided conveyance path (the recording material conveyance path) is described with the drawings.

### (Entire Constitution of Image Forming Apparatus)

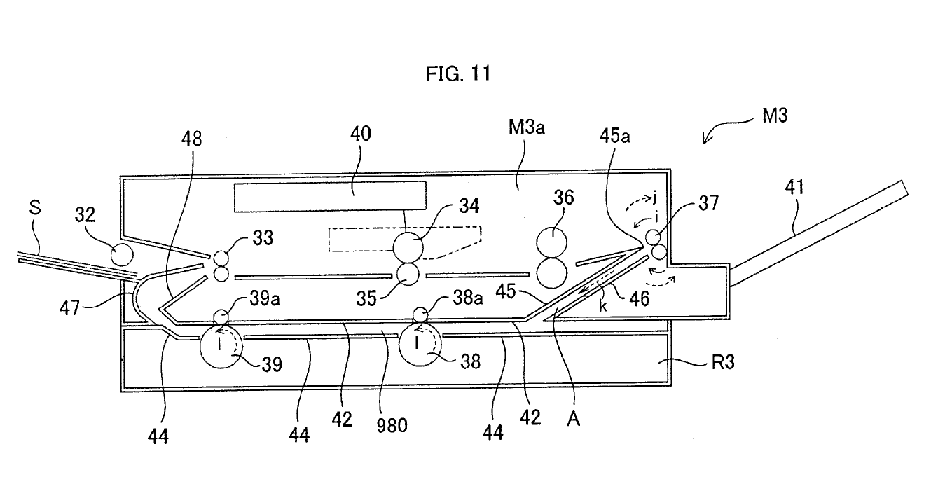

First, the entire constitution of the image forming apparatus is described with reference to FIG. 11. FIG. 11 is a cross-sectional view illustrating a schematic constitution of the image forming apparatus according to this embodiment.

In FIG. 11, an image forming apparatus M3 using an electrophotographic system has a feed roller 32, a registration roller pair 33, a photosensitive drum (an electrophotographic photosensitive member) 34 as an image bearing member, a transfer roller 35, a fixing roller pair 36, a normally and reversely rotatable discharging roller 37, conveyance rollers 38 and 39, rollers 38a and 39a respectively in press-contact with the conveyance rollers 38 and 39, a laser scanner 40, and a discharge and stack tray 41. The image forming apparatus M3 further has a recording material conveyance path 51 constituted of guides 45 and 46, and a recording material conveyance path 52 constituted of guides 47 and 48. The recording material conveyance paths 51 and 52 constitute a recording material conveyance path 980, which is for use in conveying a recording material S again to image forming unit so that an image is formed on the second surface of the recording material S with an image formed on the first surface by the image forming unit.

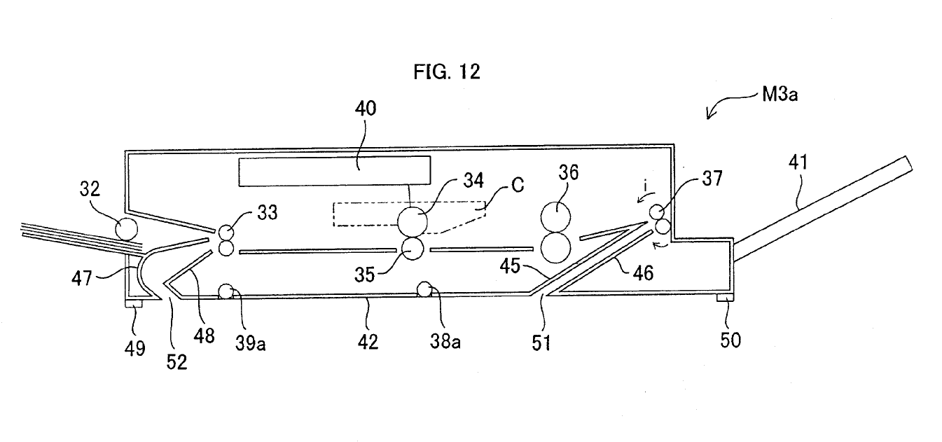

FIG. 12 is a schematic cross-sectional view illustrating an image forming apparatus body (hereinafter, referred to as an apparatus body) M3a of the image forming apparatus M3 illustrated in FIG. 11, which can perform only one-sided printing.

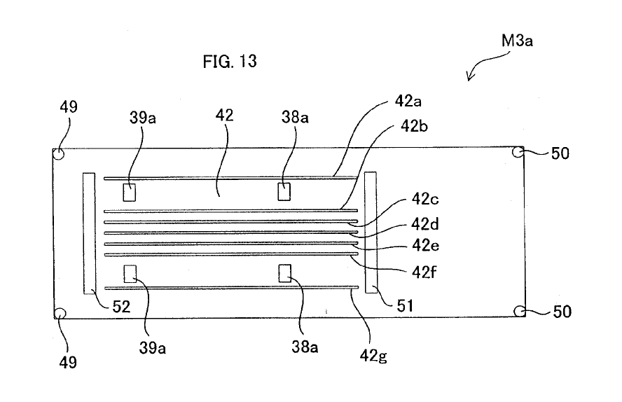

In FIG. 12, the apparatus body M3a has an exterior portion 42 provided in the bottom portion (lower portion) and rubber feet 49 and 50 supporting the apparatus body M3a. The apparatus body M3a further has the rollers 38a and 39a provided in the lower portion (bottom portion). FIG. 13 is a bottom side (rear surface side and lower side) view of the apparatus body M3a.

In FIG. 13, the exterior portion 42 has ribs 42a, 42b, 42c, 42d, 42e, 42f, and 42g.

In such a state that the apparatus body M3a is installed, the rubber feet 49 and 50 are provided so as to protrude downward in the vertical direction (the bottom side of the apparatus body M3a) more than the ribs 42a, 42b, 42c, 42d, 42e, 42f, and 42g. According to this constitution, the ribs 42a, 42b, 42c, 42d, 42e, 42f, and 42g are not in contact with a floor (an installation surface).

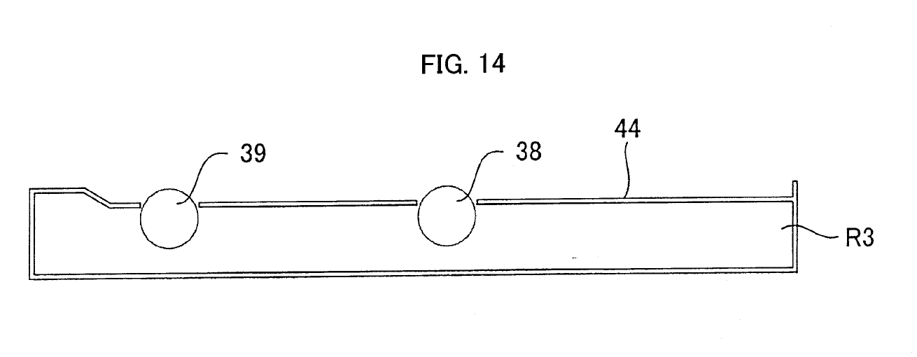

FIG. 14 is a schematic cross-sectional view illustrating a two-sided unit R3 as a conveyance unit removably provided on the lower portion of the image forming apparatus M3 illustrated in FIG. 11, and the two-sided unit R3 is removed from the image forming apparatus M3.

As illustrated in FIG. 14, the two-sided unit R3 has a guide 44 as a guide part constituting the recording material conveyance path 980 and the conveyance rollers 38 and 39.

Returning to FIG. 11, the two-sided unit R3 illustrated in FIG. 14 is mounted to the lower portion of the apparatus body M3a illustrated in FIG. 12, whereby the two-sided unit R3 is in electrically and mechanically contact with the apparatus body M3a, and the conveyance rollers 38 and 39 are in a drivable state.

Then, the conveyance roller 38 and the roller 38a are in a press-contact state, and the conveyance roller 39 and the roller 39a are in a press-contact state, whereby the recording material S can be conveyed.

The two-sided unit R3 includes a recess (containing portion), and the rubber feet 49 and 50 are contained in the recess.

Next, returning to FIG. 12, the operation of the apparatus body M3a is described.

In FIG. 12, the recording material S contained in a feeding part is separated and fed one by one by the feed roller 32 to be conveyed to the registration roller pair 33. The registration roller pair 33 corrects the skew of the recording material S and restarts the feeding of the recording material S at a predetermined timing.

In a process cartridge C, after the photosensitive drum 34 is uniformly charged by charging unit (not illustrated), a latent image is formed thereon by the laser beam from a laser scanner unit 40 as exposure unit. Then, toner is adhered to the latent image by development unit (not illustrated), whereby a toner image is formed on the photosensitive drum 34. The toner image formed on the photosensitive drum 34 is transferred onto the recording material S by the transfer roller 35 as transfer unit. The image bearing member (corresponding to the photosensitive drum 34), the charging unit, the exposure unit (corresponding to the laser scanner unit 40), the development unit, and the transfer unit (corresponding to the transfer roller 35) constitute image forming unit.

The recording material S transferred with the toner image is conveyed to the fixing roller pair 36, serving as fixing unit, by the conveying force of the photosensitive drum 34 and the transfer roller 35. Then, heat and pressure are applied to the recording material S, transferred with the toner image, by the fixing roller pair 36, and consequently, the toner image is fixed to the recording material S.

The recording material S fixed with the toner image is discharged on the tray 41 by the discharging roller 37 rotating in the direction of the solid arrow i.

According to the above constitution, the one-sided printing can be performed by the apparatus body M3a.

Next, returning to FIG. 11 again, the operation of the image forming apparatus M3 mounted with the two-sided unit R3 is described.

As described above, when the automatic two-sided printing is performed, the two-sided unit R3 is mounted to the lower portion of the apparatus body M3a.

As in the one-sided printing, the recording material S contained in the feeding part is separated and fed one by one by the feed roller 32 to be conveyed to the registration roller pair 33. The registration roller pair 33 corrects the skew of the recording material S and restarts the feeding of the recording material S at a predetermined timing.

After the photosensitive drum 34 provided in the process cartridge C is uniformly charged by the charging unit, a latent image is formed thereon by the laser beam from the laser scanner unit 40. Then, toner is adhered to the latent image by the development unit, whereby a toner image is formed on the photosensitive drum 34. The toner image formed on the photosensitive drum 34 is transferred onto the recording material S by the transfer roller 35.

The recording material S transferred with the toner image is conveyed to the fixing roller pair 36 by the conveying force of the photosensitive drum 34 and the transfer roller 35. Then, heat and pressure are applied to the recording material S, transferred with the toner image, by the fixing roller pair 36, and consequently, the toner image is fixed to the recording material S.

The recording material S fixed with the toner image is led by the discharging roller 37 rotating in the direction of the solid arrow i.

When printing on the second surface of the recording material S is performed, detection unit (not illustrated) detects that the rear end of the recording material S has passed a recording material guide end 45a, whereby the discharging roller 37 rotates in the direction of the dashed arrow j to make the recording material S switchback.

The switchbacked recording material S is conveyed in the direction of the dashed arrow k in the recording material conveyance path 980 by guides 45 and 46.

Further, the recording material S is conveyed to the conveyance roller pair 38 and 38a in the recording material conveyance path 980 while led by the guide 44 of the two-sided unit R3 and the ribs 42a to 42g of the exterior portion 42 of the apparatus body M3a. The recording material conveyance path 980 is constituted of the guide 44 and opposing portions (corresponding to the ribs 42a to 42g), which are portions of the exterior portion 42 and opposing the guide 44.

When the recording material S is conveyed immediately before the conveyance roller pair 38 and 38a (near the upstream side in the direction of conveying the recording material S), the recording material S is detected by detection unit (not illustrated), whereby the conveyance roller pair 38 and 38a and the conveyance roller pair 39 and 39a are rotated in the direction of the dashed arrow 1.

While the recording material S is led by the exterior portion 42 of the apparatus body M3a and the guide 44, the recording material S is conveyed in the recording material conveyance path 980 by the conveyance roller pair 38 and 38a and the conveyance roller pair 39 and 39a to be led to the guides 47 and 48. The recording material S is then conveyed again to the registration roller pair 33.

The registration roller pair 33 corrects the skew of the recording material S and restarts the feeding of the recording material S at a predetermined timing.

As in the printing on the first surface of the recording material S, the recording material S with the toner image transferred on the second surface is conveyed to the fixing roller pair 36 by the conveying force of the photosensitive drum 34 and the transfer roller 35. Thereafter, heat and pressure are applied to the recording material S by the fixing roller pair 36, and consequently, the toner image is fixed onto the second surface of the recording material S.

As in the one-sided printing, the recording material S fixed with the toner image on the second surface is discharged on the tray 41 by the discharging roller 37 rotating in the direction of the solid arrow i.

According to the above constitution, the two-sided printing can be performed.

The above constitution can provide the following effects.

Namely, the exterior portion 42 of the apparatus body M3a is used as the recording material conveyance path, whereby the height of the image forming apparatus M3 mounted with the two-sided unit R3 can be further reduced, and thus the image forming apparatus M3 can be reduced in size.

Further, the two-sided unit R3 may have only the one-side guide 44 as the guide for the recording material, and therefore, the two-sided unit R3 can be reduced in size, whereby cost reduction can be realized.

Furthermore, in this embodiment, since the lower portion of the apparatus body M3a is the recording material conveyance path, it is hardly touched by a user and is less likely to be damaged. Further, since the exterior portion 42 constituting the recording material conveyance path has the ribs, the occurrence of electrostatic adsorption can be suppressed, and the conveying resistance of the recording material can be further reduced.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-311368, filed on Dec. 5, 2008, which is hereby incorporated by reference herein in its entirety.

What is claimed is:

1. An image forming apparatus comprising:
an image forming unit forming an image on a sheet;
a housing including therein the image forming unit; and
a conveyance unit, which conveys the sheet with an image formed on a first surface by the image forming unit to the image forming unit again in order to form an image on a second surface of the sheet, and is attached to and removed from the upper portion of the housing,
wherein an image can be formed on one side of the sheet in such a state that the conveyance unit is not attached to the housing, images can be formed on the both sides of the sheet in such a state that the conveyance unit is attached to the housing, and
when the conveyance unit is attached to the housing, a conveyance path for conveying the sheet again to the image forming unit is constituted by the conveyance unit and an upper surface of the housing.

2. The image forming apparatus according to claim 1, further comprising:
a horizontal main conveyance path for conveying a sheet with an image formed by the image forming unit;
a containing portion disposed in the lower portion of the image forming unit and containing the sheet;
a curved conveyance path for guiding the sheet fed from the containing portion to the main conveyance path;
a roller which is provided in the main conveyance path through which a sheet is conveyed in a first direction and thereafter conveyed to a second direction opposite to the first direction;
a reversing path for guiding the sheet, which is conveyed in the second direction by the roller, into the conveyance path; and
a curved introduction path for guiding the sheet conveyed in the conveyance path to the main conveyance path,
wherein the conveyance path is provided above the main conveyance path and is a horizontal conveyance path.

3. The image forming apparatus according to claim 2, wherein the roller is disposed at a tail end of the main conveyance path and discharges the sheet with an image formed by the image forming unit.

4. The image forming apparatus according to claim 2, further comprising:
an opening formed in the upper surface of the housing and serving as a tail end of the reversing path; and
a shutter for closing the opening.

5. The image forming apparatus according to claim 4, wherein the shutter freely moves between a position where the opening is closed and a position where the opening is opened.

6. The image forming apparatus according to claim 2, further comprising:
an opening formed in the upper surface of the housing and serving as an entrance of the introduction path; and
a shutter for closing the opening.

7. The image forming apparatus according to claim 6, wherein the shutter freely moves between a position where the opening is closed and a position where the opening is opened.

8. The image forming apparatus according to claim 1, wherein the conveyance unit is provided with a D-shaped roller, and the sheet is held between a opposing portion, which is the upper surface of the housing and opposing the conveyance unit, and the D-shaped roller and conveyed in the conveyance path.

9. The image forming apparatus according to claim 1, wherein the upper surface of the housing has an embossing.

10. The image forming apparatus according to claim 1, wherein the upper surface of the housing has a rib.

11. An image forming apparatus comprising:
an image forming unit forming an image on a sheet;
a housing including therein the image forming unit; and
a conveyance unit, which conveys the sheet with an image formed on a first surface by the image forming unit to the image forming unit again in order to form an image on a second surface of the sheet, and is attached to and removed from the lower portion of the housing,
wherein an image can be formed on one side of the sheet in such a state that the conveyance unit is not attached to the housing, images can be formed on the both sides of the sheet in such a state that the conveyance unit is attached to the housing, and
when the conveyance unit is attached to the housing, a conveyance path for conveying the sheet again to the image forming unit is constituted by the conveyance unit and a lower surface of the housing.

12. The image forming apparatus according to claim 11, further comprising:
a horizontal main conveyance path for conveying a sheet with an image formed by the image forming unit;
a roller which is provided in the main conveyance path through which a sheet is conveyed in a first direction and thereafter conveyed to a second direction opposite to the first direction;
a reversing path for guiding the sheet, which is conveyed in the second direction by the roller, into the conveyance path; and
a curved introduction path for guiding the sheet conveyed in the conveyance path to the main conveyance path,
wherein the conveyance path is provided below the main conveyance path and is a horizontal conveyance path.

13. The image forming apparatus according to claim 11, wherein the lower surface of the housing has a rib.
